(19) United States
(12) Patent Application Publication
(10) Pub. No.: US 2015/0030423 A1
(43) Pub. Date: Jan. 29, 2015

(54) Vehicle Trailer

(71) Applicant: Glen Antony REID, Auckland (NZ)

(72) Inventor: Glen Antony REID, Auckland (NZ)

(73) Assignee: Reid Inventions Limited

(21) Appl. No.: 13/950,165

(22) Filed: Jul. 24, 2013

(51) Int. Cl. B66F 9/075; B62D 63/06; B62D 53/04

(52) U.S. Cl. CPC B66F 9/07504; B62D 53/045; B62D 63/062
USPC 414/664

(57) ABSTRACT

A vehicle trailer including a trailer chassis with two opposed sides secured together at/adjacent one end by a crossmember, to form a U-shaped structure with an interior space between the arms of said U; a load-bearing tailgate between the sides of said chassis to removably close off said interior space; a loading device mounted in said interior space adjacent said crossmember and including a loading fork which can be moved up and down and which provides at least one load-engaging member; the or each said load-engaging member having a length such that the end of said load-engaging member furthest from said crossmember can be positioned to engage said load-bearing tailgate so as to stabilise said load-engaging member and to transfer load from said load-engaging member to said tailgate.

### TECHNICAL FIELD

The present invention relates to a trailer adapted to be towed by a towing vehicle, and in particular to a trailer equipped with one or more load-bearing forks for picking up a load to be transported by the trailer.

### BACKGROUND ART

A number of trailer designs have been proposed for carrying a load on load-bearing forks:—see for example, U.S. Pat. Nos. 6,033,177, 7,326,022, 5,584,639 and 5,415,516, and WO94/06711.

However, in all of these designs, a load being transported is transported simply balanced on the load-bearing forks, and this obviously limits the maximum weight which can be transported:—the load is unstable and both the load and the forks tend to bounce in transit.

### DISCLSOURE OF THE INVENTION

An object of the present invention is the provision of a vehicle trailer which overcomes at least some of the drawbacks of the prior art trailers.

The present invention provides a vehicle trailer which includes:
a trailer chassis mounted upon ground engaging means;
said chassis having two opposed sides to which said ground engaging means are connected;
said sides being secured together at or adjacent one end thereof by a crossmember, to form a structure which is substantially U-shaped in plan, with an interior space between the arms of said U;
the end of said chassis adjacent said crossmember being provided with means for securing the trailer to a towing vehicle;
the opposite end of said chassis being provided with a load-bearing tailgate arranged to extend between the sides of said chassis so as to removably close off said interior space;
a loading device mounted in said interior space adjacent said crossmember;
said loading device including a loading fork which is adapted to be moved up and down and which provides at least one load-engaging member for engagement with a load;
the or each said load-engaging member having a length such that the end of said load-engaging member furthest from said crossmember can be positioned to engage said load-bearing tailgate so as to stabilise said load-engaging member and to transfer load from said load-engaging member to said tailgate.

Normally, the ground engaging means would be wheels. However, the ground engaging means could be, for example, skids or tracks.

Preferably, the ground engaging means consists of wheels arranged in tandem pairs, with one pair connected to each side of the trailer. Preferably also, each wheel of each tandem pair is supported upon a stub axle mounted upon a swing arm pivotally connected to the chassis, and shock absorbing means (for example leaf springs or airbag shock absorbers) are connected between each swing arm and the chassis. Preferably also, the shock absorbing means of each tandem pair of wheels are interconnected by means of a pivot plate supported from the chassis, to facilitate load distribution between the shock absorbing means.

Normally, the loading fork would be a conventional forklift fork, with two load-engaging members in the form of tines. However, the loading fork could provide only a single tine, or multiple tines, or even a solid loading platform, as load-engaging members; as used herein, the term “loading fork” shall include all these variants.

The tailgate may be constructed in a variety of different forms, providing that it can be moved clear of the interior space to load the trailer, and providing it is capable of load-bearing engagement with the load-engaging members of the loading fork.

Preferably, one end of the tailgate is pivoted to the chassis such that the tailgate can pivot in a substantially horizontal plane; most preferably, the tailgate is pivoted to the chassis such that it can also pivot upwards, e.g. in a substantially vertical plane or in a plane at an angle to the vertical.

In one embodiment, the surface of the tailgate which in use is in load transmitting engagement with a load-engaging member is formed with an indentation shaped to receive the load-engaging member. Further, the portion of a load-engaging member which in use is in load transmitting engagement with tailgate may be adapted to be releasably secured to the tailgate.

In further variants, the tailgate may be formed in two parts, with one part pivoted to each side of the chassis. The two parts are provided with means for releasably securing them together, and may also be configured to interlock with each other.

In a simpler version of the tailgate arrangement, the tailgate may be supported across the end of the chassis by means of supporting brackets, and is removed by sliding or lifting the tailgate clear of the rear of the trailer when the trailer is to be loaded.

In another variation, the tailgate may be formed as two or more portions which are hinged together, so that the tailgate occupies less space when it is pivoted out of the way for loading.

### BRIEF DESCRIPTION OF THE DRAWINGS

By way of example only, embodiments of the present invention are described in detail, with reference to the accompanying drawings in which:

FIG. 1 is a side view of a trailer in accordance with the present invention;

FIG. 2 is a plan view of the trailer of FIG. 1 on a reduced scale;

FIG. 3 is an end view in the direction of arrow 3, of the trailer of FIG. 1;

FIG. 3a is an isometric view on a larger scale, of a detail of FIG. 3;

FIG. 3b is an end view similar to FIG. 3, but showing a first variant design;

FIG. 4 is a side view of part of one side of the trailer of FIG. 1;

FIG. 5 is an end view of a trailer, showing a second variant tailgate design;

FIG. 6 is an end view of a trailer, showing a third variant tailgate design;

FIG. 7 is an end view of a trailer, showing a fourth variant tailgate design; and

FIG. 8 is a view of the design of FIG. 7, showing the tailgate part raised.

### DETAILED DESCRIPTION OF PREFERRED EMBODIMENTS

Referring to the drawings, a trailer 10 in accordance with the present invention includes two opposed parallel sides 11, 12 joined together at one end by a crossmember 13 to form a structure which is generally U-shaped in plan. A drawbar 14 carrying a tow hitch (not shown) is rigidly secured to the end of the trailer adjacent the crossmember 13. The drawbar structure and the type of tow hitch may be any of a known range of types, depending upon the intended towing vehicle.

Each side of the trailer may be provided with a stabilising jockey wheel of known type (not shown) adjacent each end of the crossmember 13.

Each side 11, 12 of the trailer is supported by a pair of wheels 14/15, 16/17, which are secured to the corresponding side as described below, without any cross axles, so that the interior space defined by the sides 11, 12 and cross member 13 is left clear to io receive cargo, apart from loading forks 18. The loading forks 18 are supported upon a mounting frame 19 secured to the crossmember 13, such that the length of the forks 18 extend parallel to the length of the sides 11, 12.

In the embodiment shown, a conventional pair of forks 18, which uses two parallel tines, is shown. However, depending upon the types of load to be loaded on the trailer, a single tine, or multiple tines, or a flat tray, could be used.

The loading forks 18 include two substantially horizontal parallel tines 18a, 18b, each of which is rigidly secured to an upright 20, 21, the free end of which is mounted on a carrier 22.

The carrier 22 is mounted upon the mounting frame 19 such that the carrier 22, and the attached forks 18, can be reciprocated in a substantially vertical plane. The mechanism for reciprocating the carrier 22 and the forks 18 may be any of a wide range of suitable robust mechanisms, and may be mechanical, pneumatic, hydraulic or electrical.

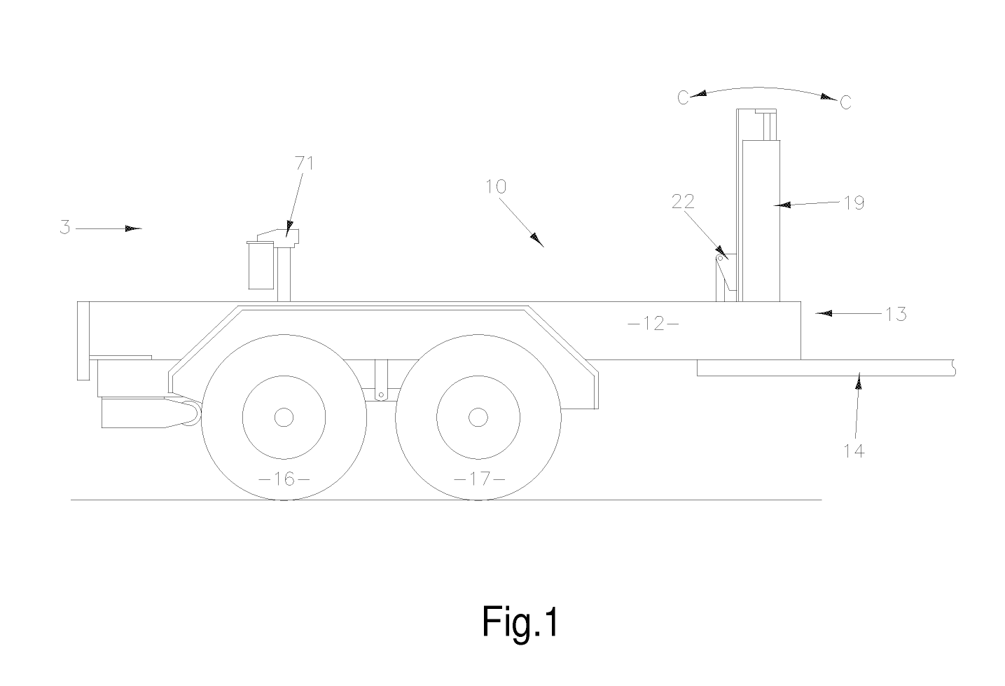

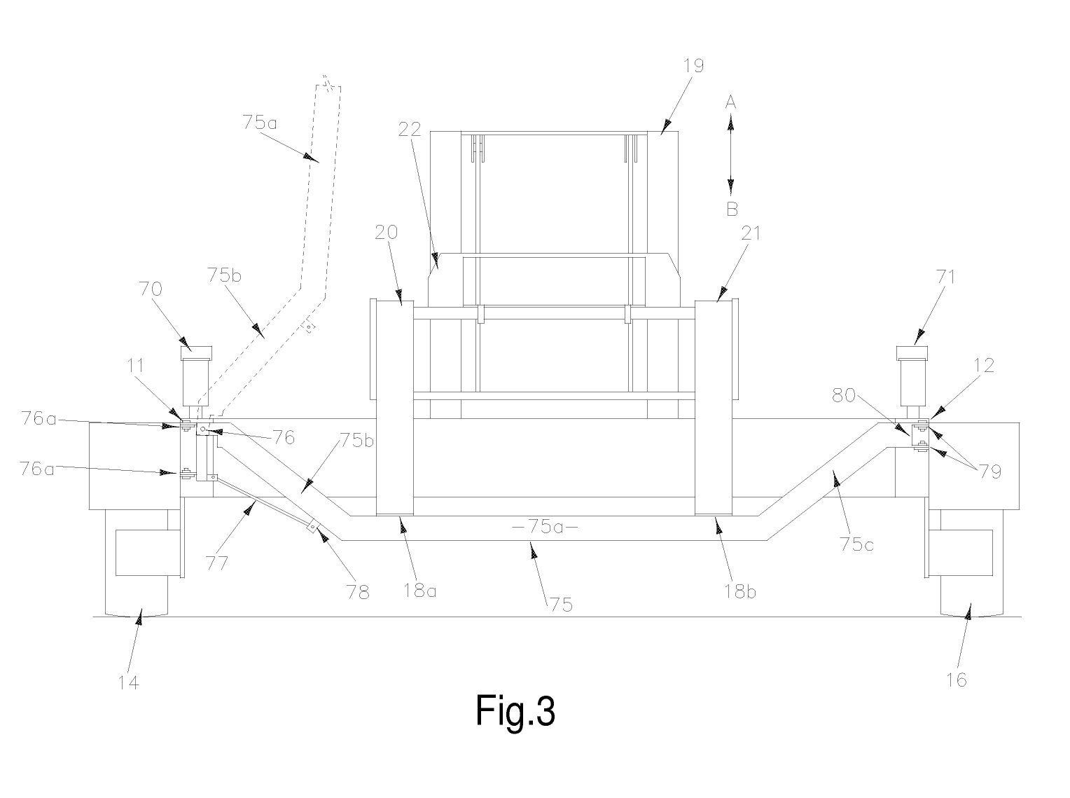

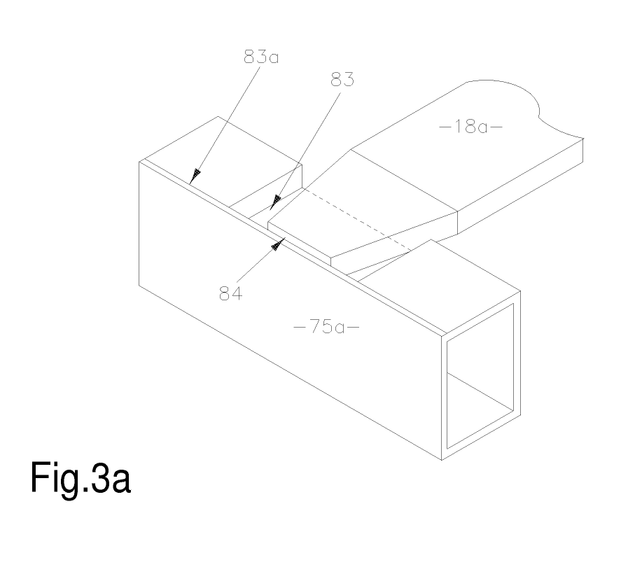

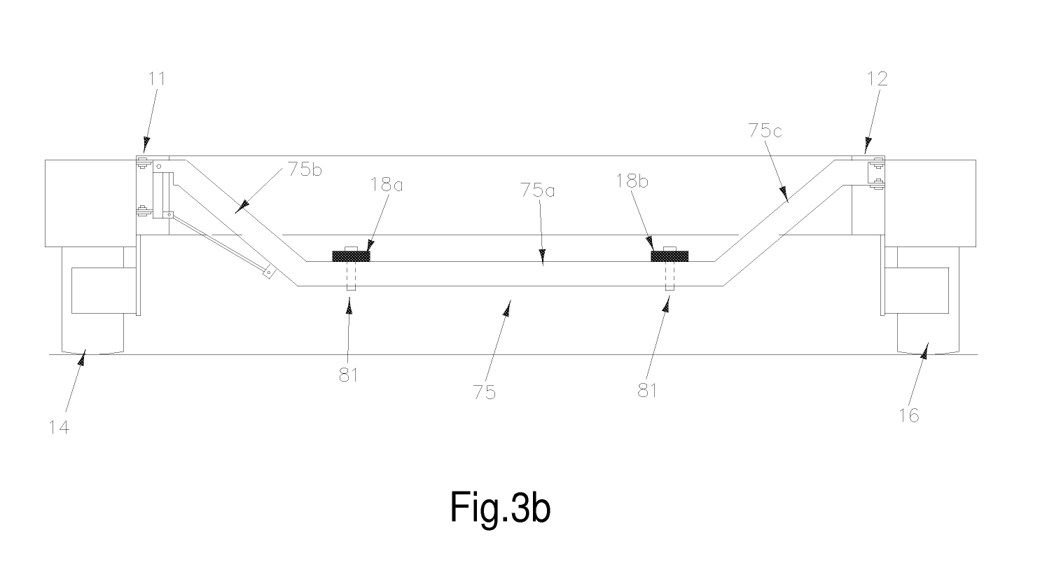

The mechanism shown in the drawings is a conventional forklift mechanism which is of known type and therefore is not described in detail. It should be noted that this mechanism permits both the reciprocating movement of the carrier 22 and the forks 18 up and down the length of the mounting frame 19, as indicated by arrows A and B in FIG. 3, and also permits the pivotal movement of the mounting frame 19 in the directions indicated by arrows C in FIG. 1.

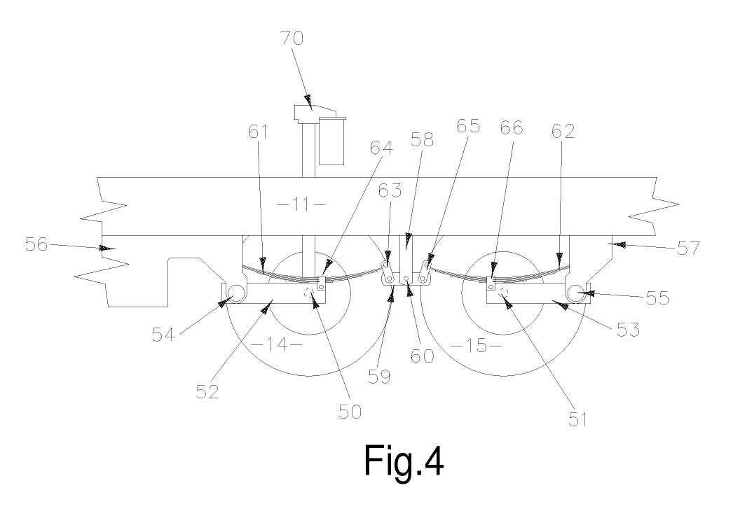

As shown in particular in FIG. 4, each set of ground engaging wheels 14/15, 16/17 consists of wheels arranged as a tandem pair, each wheel being directly supported from the corresponding side of the trailer, to avoid the need for a cross axle.

The arrangement is described with particular reference to the pair of wheels 14/15 secured to the side 11; the wheels 16/17 are secured to the side 12 in an identical manner. Each wheel 14, 15 of the tandem pair 14/15 is mounted on a stub axle 50, 51 which is mounted on one end of a swing arm 52, 53, the opposite end of which is pivoted by a pivot 54, 55 to a supporting bracket 56, 57, which is rigidly secured to the io underside of the side 11. An intermediate supporting bracket 58 is mounted between the wheels 14, 15 and carries a rocker plate 59 which can pivot on a pivot 60 in a plane parallel to the plane of the wheels 14/15.

To provide a suspension for the trailer, a leafspring 61, 62 is associated with each wheel 14, 15, respectively. The leafspring 61 is secured at one end to the bracket 56, and at the other end to a bracket 63 which is pivoted to the adjacent end of the rocker arm 59. Adjacent the midpoint of the leafspring 61, the leafspring is secured to the swing arm 52, adjacent the stub axle 50, by a bracket 64.

In similar manner, the leafspring 62 is secured between the bracket 57 and a bracket 65 pivoted to the adjacent end of the rocker arm 59; the leafspring 62 is secured adjacent its midpoint to the swing arm 53 by a bracket 66.

The above described suspension system allows each of the wheels in each tandem pair to move semi-independently, but also provides a connection between the suspension systems, via the rocker plate 59, so that the loading on the wheels in each tandem pair can be equally distributed between the wheels.

An electric jack 70, 71 is mounted on each side immediately above the stub axle of the rearmost wheel of each pair. When the jack is extended as shown in FIG. 4 it contacts the upper surface of the leafspring associated with the rearmost wheel and pushes down on the spring to the full extent of the movement permitted by the rocker plate 59, to disengage the front wheels 15, 17 from the ground. This is used to manoeuvre the trailer when it is not engaged with a tow vehicle:—in this position, the small electric moving motors (only one of which, 71a, is visible in FIG. 1) can be brought into contact with the rearmost wheels 14, 16 to rotate the wheels and move the trailer.

Tandem wheels generally are desirable, because the loads carried by trailers of this type tend to be heavy, but single wheels, or more than two wheels per side, could be used if necessary. If a single wheel is used, then the end of the leafspring which in the tandem wheel pair is secured to the pivoted bracket 63, 65, would simply be secured directly to the supporting bracket 58.

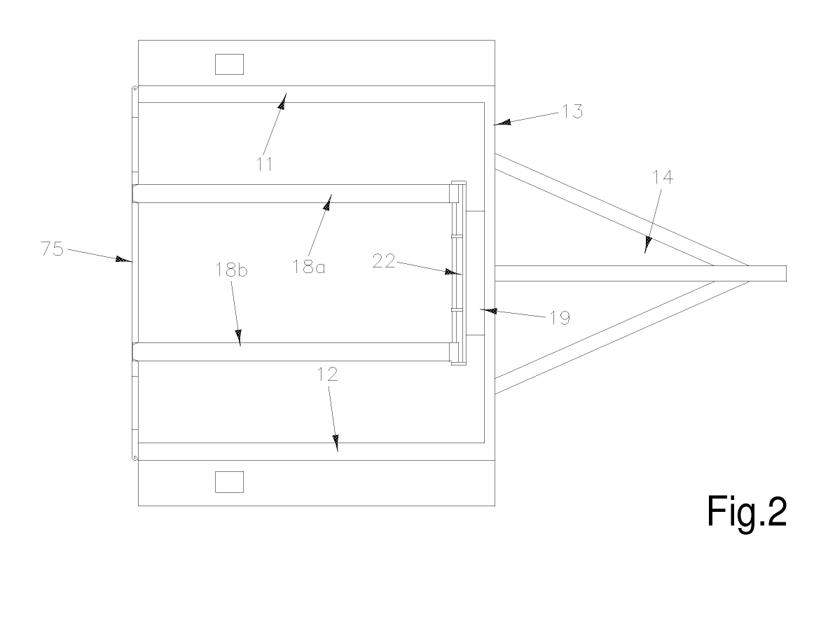

The otherwise-open rear of the trailer is closed off by a removable tailgate 75 (visible in FIGS. 2 and 3 only). The tailgate 75 is secured at each end to the end of the adjacent side 11, 12 respectively and includes a central horizontal portion 75a with an inclined portion 75b, 75c formed integrally with each end.

The free end of the portion 75b is pivoted to the end of the side 11 by a pivot 76 which permits the tailgate, when released from the side 12, to pivot upwards to the position shown in broken lines in FIG. 3. The tailgate is biased towards the upwards position, and stabilised in the upwards position, by a gas strut 77 of known type which is pivoted between the end of the side 11 and a bracket 78 secured to the portion 75b.

The tailgate 75 can also pivot in a horizontal plane on pivot pins 76a which are arranged between brackets formed on the end of the side 11 and on brackets connected to the portion 75b of the tailgate. This upwards plus horizontal movement of the tailgate allows the tailgate to be moved well out of the way during loading, and then correctly positioned underneath the forks 18 after loading.

The free end of the portion 75c is releasably secured by a pair of spaced removable pins 79 to a bracket 80 provided on the end of the side 12.

The height above the ground of the upper surface of the central portion 75a of the tailgate corresponds to the optimum height of the tines 18a, 18b, of the forks 18 when the forks are carrying a load. Further, the length of the tines 18a, 18b is such that when the tailgate 75 is closed across the end of the trailer, the underside of each tine rests on the upper surface of the portion 75a of the tailgate.

As shown in FIG. 3a, the central portion 75a of the tailgate is formed with a pair of spaced indentations 83 (only one of which is shown in FIG. 3a) which receives the tip of the corresponding tine 18a when that tine is in load transmitting engagement with the tailgate. In this position, the end 84 of the tine rests in the indentation 83 and also is restrained from moving beyond the tailgate 75 in a horizontal plane by the upper edge 83a of the indentation 83.

Providing the trailer with a tailgate helps to stiffen and brace the trailer, given its open shape, and also helps to maintain correct wheel alignment. Further, the presence of the tailgate may be of assistance in retaining the load on the forks. However, designing the tailgate so that in use the ends of the fork tines rest on, and are in load transmitting engagement with, the tailgate, is a significant advantage in that it supports and stabilises the forks 18 and also assists in distributing the load from the forks 18 over the trailer chassis via the tailgate. The overall result is that the trailer can carry a heavier load both safely and stably.

The use of the tailgate also makes the trailer less hazardous to other road users in the case of an accident, since it provides an additional barrier to any vehicle colliding with the trailer from behind, and thus protects such a vehicle from becoming impaled on the forks.

In use, the trailer is loaded by releasing the pins 79 to open the tailgate and allow it to swing upwards to the position shown in broken lines in FIG. 3. The height of the forks 18 is then adjusted in known manner to the correct height for picking up the specified load, and the trailer is backed towards the load until the forks 18 engage the load in known manner and the load lies between the sides 11, 12 of the trailer. The forks 18 are then raised in known manner to a safe travelling height, and the tailgate 75 is pivoted to the closed position and secured across the rear of the trailer. The forks 18 may be moved to an initial position slightly higher than the upper surface of the centre section 75a of the tailgate 75 initially, and then lowered slightly until they are in load-bearing engagement with the tailgate as described above, before the load is transported.

It will be appreciated that the tailgate 75 could be pivoted to swing only outwards in a substantially horizontal plane, rather than upwards, but this is in general less convenient for loading.

The tailgate 75 is shown as a single beam, but depending upon the loading anticipated, it may be formed having a greater thickness. In addition, if greater load security is required, the sides 11, 12 of the trailer may support high protective sides and/or the tailgate 75 may support a high protective rear gate.

For additional security during transport, the fork tines 18a, 18b, may be sized so that they extend just over the tailgate in the closed position, as shown in FIG. 3b, and the tips of the tines may be pinned to the tailgate by pins 81. Alternatively, the tips of the tines could be pinned to the tailgate electromagnetically.

Another possibility is to secure the tips of the tines to the underside of the tailgate, so that load is transferred from the tines to the tailgate by loading the tailgate in tension from below, rather than in compression from above. In this case, the level at which the forks 18 carry the load is adjusted downwards, so that the tips of the tines contact the underside of the tailgate rather than the upper surface.

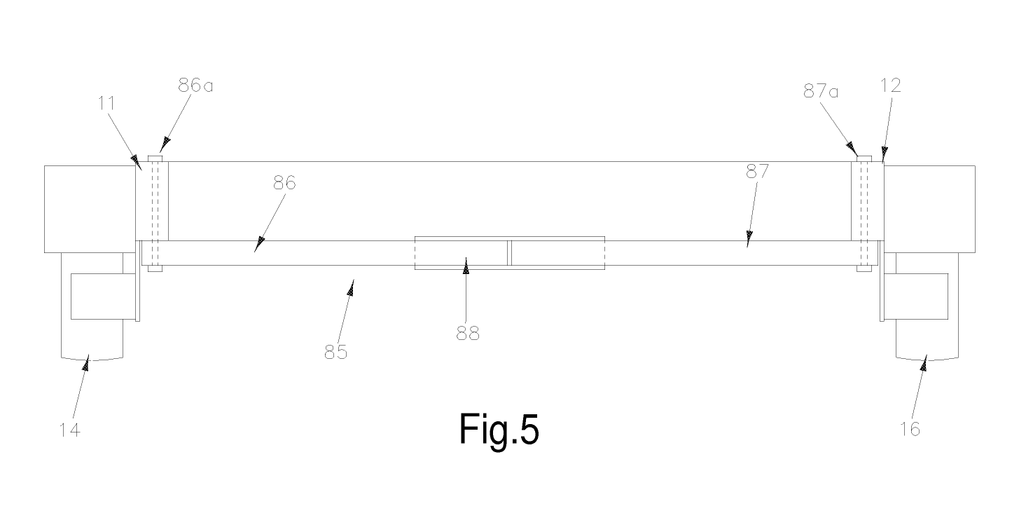

A number of possible variant designs of the tailgate are shown in FIGS. 5-8.

FIG. 5 shows an end view of a two-part tailgate:—the tailgate 85 is made as two identical parts 86, 87, each of which is hinged at one end to the adjacent side 11, 12 of the trailer by hinge pins 86a, 87a. The two parts are secured together in the middle of the tailgate by a channel section 88 which is secured over the join, (e.g. by securing pins). Each part 86, 87 of the tailgate is arranged to hinge outwards and in a substantially horizontal plane, but alternatively could be arranged to hinge both upwards and outwards, in the same manner as described with reference to FIG. 3.

In a variant of the design shown in FIG. 5, the ends of the two parts 86, 87 are formed so as to releasably interlock with each other.

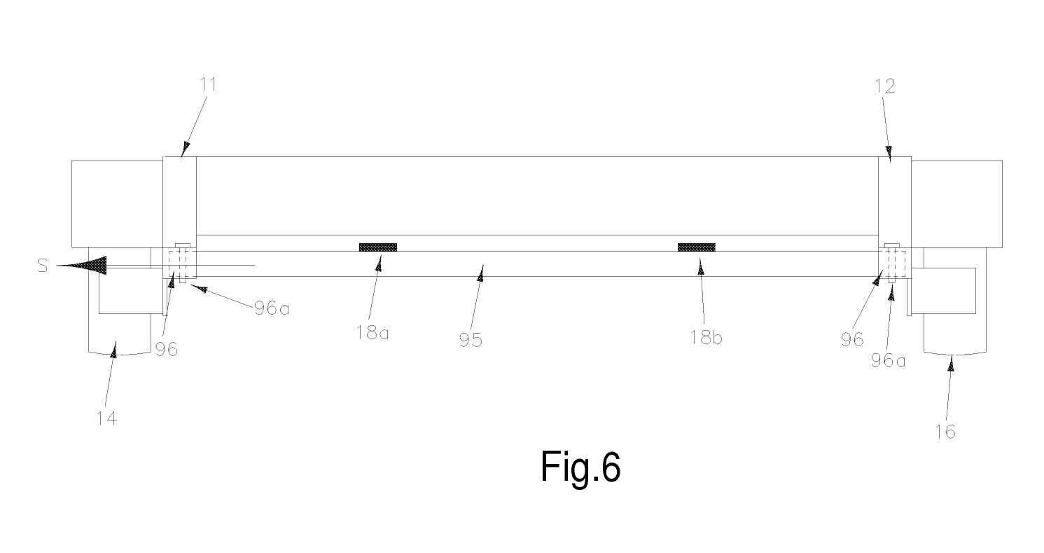

FIG. 6 shows a variant in which the tailgate 95 is formed as a completely removable component which is secured in sockets 96 secured to the ends of the sides 11, 12. The tailgate 95 is removed by releasing securing pins 96a holding the ends of the tailgate into the sockets 96, and lifting the tailgate 95 out of the sockets 96, or by sliding the tailgate 95 in the direction of arrow S until the tailgate is clear of the sockets 96. The tailgate is replaced in the same manner once the trailer has been loaded.

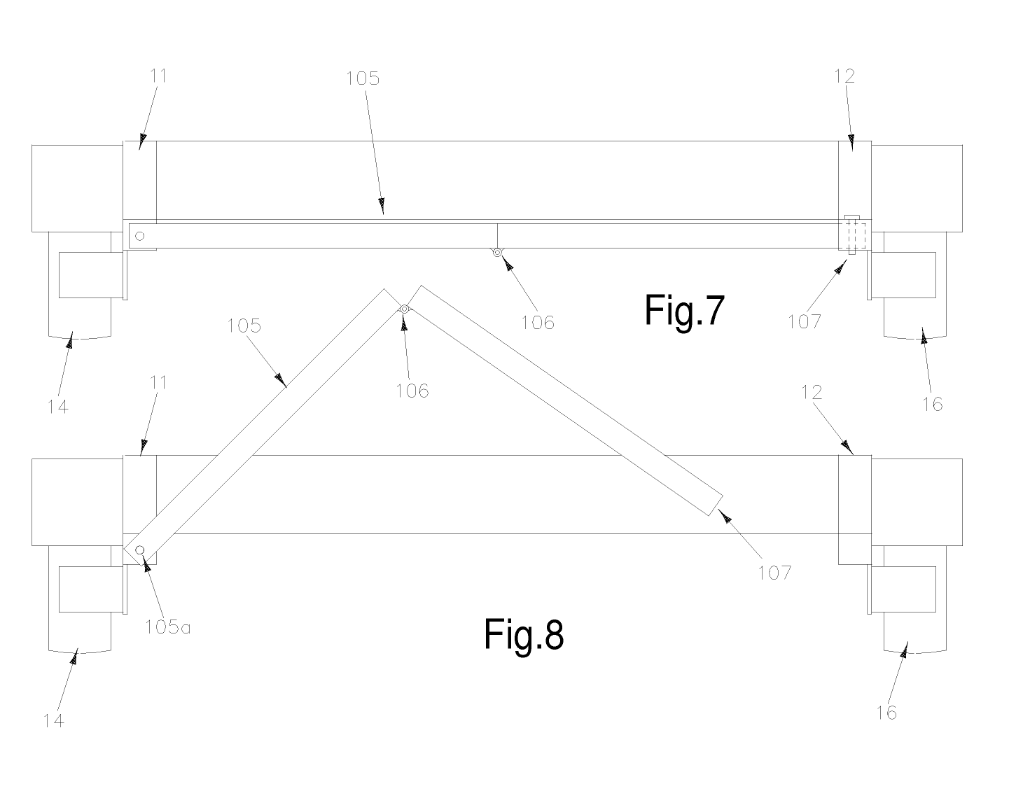

FIGS. 7 and 8 shows a variant in which the tailgate 105 is pivoted at one end by a pivot 105a to the end of the side 11, and the tailgate 105 is provided with a central hinge 106 such that when the end 107 is released from securement to the side 12, the tailgate can be pivoted upwards to the position shown in broken lines, with the two parts of the tailgate hinged together, to reduce the upward extension of the tailgate. More than one hinge 106 could be used, and the tailgate divided into three or more hinged parts.

10

1. A vehicle trailer which includes:
a trailer chassis mounted upon ground engaging means;
said chassis having two opposed sides to which said ground engaging means are connected;
said sides being secured together at or adjacent one end thereof by a crossmember, to form a structure which is substantially U-shaped in plan, with an interior space between the arms of said U;
the end of said chassis adjacent said crossmember being provided with means for securing the trailer to a towing vehicle;
the opposite end of said chassis being provided with a load-bearing tailgate arranged to extend between the sides of said chassis so as to removably close off said interior space;
a loading device mounted in said interior space adjacent said crossmember;
said loading device including a loading fork which is adapted to be moved up and down and which provides at least one load-engaging member for engagement with a load;
the or each said load-engaging member having a length such that the end of said load-engaging member furthest from said crossmember can be positioned to engage said load-bearing tailgate so as to stabilise said load-engaging member and to transfer load from said load-engaging member to said tailgate.

2. The trailer as claimed in claim 1, wherein one end of said tailgate is pivoted to said chassis such that said tailgate can pivot in a substantially horizontal plane.

3. The trailer as claimed in claim 2, wherein said one end of said tailgate is pivoted to said chassis such that said tailgate can also pivot upwards.

4. The trailer as claimed in claim 1, wherein the surface of the tailgate which in use is in load transmitting engagement with the or each load-engaging member, is formed with an indentation shaped to receive the or each load-engaging member.

5. The trailer as claimed in claim 1, wherein the portion of the or each load-engaging member which in use is in load transmitting engagement with the tailgate, is adapted to be releasably secured to said tailgate.

6. The trailer as claimed in claim 1, wherein said tailgate is formed in two parts, one part of said tailgate being pivoted to one side of the chassis, and the other part of the tailgate being pivoted to the other side of the chassis; said tailgate being provided with means for releasably securing said two parts together.

7. The trailer as claimed in claim 6, wherein said two parts are configured to releasably interlock with each other.

8. The trailer as claimed in claim 1, wherein the tailgate is adapted to be removable from said trailer.

9. The trailer as claimed in claim 8, wherein said tailgate is removably supported across said opposite end of said chassis by means of supporting brackets.

10. The trailer as claimed in claim 1, wherein said tailgate is formed as two or more portions hinged together.

11. The trailer as claimed in claim 1, wherein said ground engaging means comprise tandem wheels connected to each side of the trailer, each wheel of each tandem pair being supported upon a stub axle mounted upon a swing arm pivotally connected to the chassis.

12. The trailer as claimed in claim 11, wherein each wheel of each tandem pair is connected to the chassis via a shock absorbing means connected between said swing arm and said chassis; the shock absorbing means of each tandem pair of wheels being interconnected by means of a pivot plate to facilitate load distribution between said shock absorbing means.
